(19) United States
(12) Patent Application Publication
(10) Pub. No.: US 2024/0422316 A1
(43) Pub. Date: Dec. 19, 2024

(54) SPATIAL FREQUENCY TRANSFORM BASED IMAGE MODIFICATION USING INTER-CHANNEL CORRELATION INFORMATION

(71) Applicant: HUAWEI TECHNOLOGIES CO., LTD., Shenzhen (CN)

(72) Inventors: Kai Cui, Munich (DE); Atanas Boev, Munich (DE); Eckehard Steinbach, Munich (DE); Elena Alexandrovna Alshina, Munich (DE); Ahmet Burakhan Koyuncu, Munich (DE)

(21) Appl. No.: 18/818,526

(22) Filed: Aug. 28, 2024

Related U.S. Application Data
(63) Continuation of application No. PCT/EP2022/070038, filed on Jul. 18, 2022.

(30) Foreign Application Priority Data
Feb. 28, 2022 (WO) PCT/EP2022/054976

(51) Int. Cl. H04N 19/12; H04N 19/119; H04N 19/17; H04N 19/33; H04N 19/42; H04N 19/625; H04N 19/63

(52) U.S. Cl. CPC H04N 19/12; H04N 19/119; H04N 19/17; H04N 19/33; H04N 19/42; H04N 19/625; H04N 19/63

(57) ABSTRACT

The present disclosure relates to image modification such as an image enhancement wherein the processing is at least partially based on neural networks. In particular, the image modification includes a multi-channel processing in which a primary channel is processed separately and secondary channels are processed based on the processed primary channel. The primary channel is processed based on a first spatial frequency transform to obtain a transformed primary channel and the secondary channel is processed based on a second spatial frequency transform to obtain a transformed secondary channel. The transformed primary channel is processed by means of a first neural network to obtain a modified transformed primary channel and the transformed secondary channel is processed based on the transformed primary channel by means of a second neural network to obtain a modified transformed secondary channel.

### CROSS-REFERENCE TO RELATED APPLICATIONS

This application is a continuation of International Application No. PCT/EP2022/070038, filed on Jul. 18, 2022, which claims priority to International Patent Application No. PCT/EP2022/054976, filed on Feb. 28, 2022. The disclosures of the aforementioned applications are hereby incorporated by reference in their entireties.

### TECHNICAL FIELD

Embodiments of the present disclosure generally relate to the field of encoding and decoding databased on a neural network architecture. In particular, some embodiments relate to methods and apparatuses for such encoding and decoding images and/or videos from a bitstream and, particularly, image enhancement, using a plurality of processing layers.

### BACKGROUND

Hybrid image and video codecs have been used for decades to compress image and video data. In such codecs, a signal is typically encoded block-wisely by predicting a block and by further coding only the difference between the original bock and its prediction. In particular, such coding may include transformation, quantization and generating the bitstream, usually including some entropy coding. Typically, the three components of hybrid coding methods—transformation, quantization, and entropy coding—are separately optimized. Modern video compression standards like High-Efficiency Video Coding (HEVC), Versatile Video Coding (VVC) and Essential Video Coding (EVC) also use transformed representations to code a residual signal after prediction.

Recently, neural network architectures have been applied to image and/or video coding. In general, these neural network (NN) based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approaches have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between different devices, e.g. between encoder and decoder, or a device and a cloud, a feature map at the output of the site of splitting (e.g. a first device) is compressed and transmitted to the remaining layers of the neural network (e.g. to a second device).

Further improvement of encoding and decoding using trained network architectures may be desirable.

### SUMMARY

The present invention relates to methods and apparatuses for modifying, e.g. enhancing, an image or a video.

The foregoing and other objects are achieved by the subject matter of the independent claims. Further implementation forms are apparent from the dependent claims, the description and the figures.

Particular embodiments are outlined in the attached independent claims, with other embodiments defined in the dependent claims.

In particular, embodiments of the present invention provide an approach for modifying an image which is based on a neural network system processing multiple image channels. A primary channel is processed individually. One or more secondary channels are processed taking into account information from the primary channel. Prior to the processing by the neural network system, the first and secondary channel(s) are subject to a spatial frequency transform. Prior to the processing by the neural network system, it may be selected which image channel is the primary channel.

According to a first aspect, the present disclosure relates to a method of modifying an image region represented by two or more image channels, the method comprising processing a primary channel of the two or more image channels based on a first spatial frequency transform to obtain a transformed primary channel and processing a secondary channel of the two or more image channels different from the primary channel based on a second spatial frequency transform to obtain a transformed secondary channel.

The two or more image channels may include a color channel and/or a feature channel. Color channels and feature channels reflect the image characteristics. Each kind of channel may provide information not present in other channel, so that collaborative processing may improve the channels with respect to the primary channel. For example, the two or more image channels are YUV channels and the primary channel may be the Y channel. The image region may be a patch of a predetermined size corresponding to a part of an image or a part of a plurality of images or the image region may be an image or a plurality of images. The image may be a still image or a frame of a video sequence.

Further, the method according to the first aspect comprises processing the transformed primary channel by means of a first neural network to obtain a modified transformed primary channel and processing the transformed secondary channel based on the transformed primary channel (used as auxiliary information) by means of a second neural network to obtain a modified transformed secondary channel. The first and second networks may be different from each other and they may operate independently of each other.

The method according to the first aspect, furthermore, comprises processing the modified transformed primary channel based on a first inverse spatial frequency transform to obtain a modified primary channel and processing the modified transformed secondary channel based on a second inverse spatial frequency transform to obtain a modified secondary channel. Based on the modified primary channel and the modified secondary channel a modified image region is obtained.

The first and second spatial frequency transforms provide information in a spatial frequency domain without being restricted thereto. It is noted that transformation by the spatial frequency transform can be regarded as a kind of “preconditioning” wherein a signal is transformed into a more redundant format before processed further. A more redundant signal is easier for the neural network to process.

In order to improve the quality of the modified image region information on the primary channel is used as auxiliary information for processing the secondary channel. The auxiliary information is given in a spatial frequency transform domain and is conveniently added to the spatial frequency transformed secondary channel before input to the second neural network. The transformed primary channel can be processed independently from the second neural network by the first neural network. Thus, coefficients of one of the neural networks can be changed/optimized without affecting the output of the other network. Thereby, the overall conditioning/optimization of the neural networks can be performed rather quickly. Further, different kernels may be used for the first and second neural networks if they are implemented as convolutional networks. Particularly, according the method of the first aspect, there is no need for processing all channels by one and the same network at some stage in order to obtain modified channels. Thereby, time consumption of the overall processing can be reduced as compared to the art.

According to an implementation, each of the first neural network and the second neural network is or comprises a convolutional neural network (CNN). CNNs have proven superior to other networks, for example, multiple perceptrons, in many image processing applications and are known for relatively robust and fast processing. Each of the convolutional neural networks may comprise at least one residual network component allowing for residual learning with reduced memory demands. One or more of the convolutional neural networks may use a scaling layer represented by one or more scaling values. Accordingly, the scaling layer may be adapted for signaling the one or more scaling values.

In a possible implementation, one or both of the first spatial frequency transform and the second spatial frequency transform are selected from a group consisting of a wavelet transform, a Discrete Fourier Transform, a Fast Fourier Transform and energy compacting transforms comprising a Discrete Cosine Transform. The spatial frequency transforms can be chosen depending on the actual applications that might demand for different transforms in order to achieve a desired quality of the modified image region. The first spatial frequency transform and the second spatial frequency transform may be the same (one of a wavelet transform, a Discrete Fourier Transform, a Fast Fourier Transform, an energy compacting transform and a Discrete Cosine Transform).

Depending on the actual application and with respect to processing speed and memory demand selection of a wavelet transform might be suitable. In this case, one or both of the first spatial frequency transform and the second spatial frequency transform may be a wavelet transform selected from a group consisting of a discrete wavelet transform (DWT) and a stationary wavelet transform. If a DWT is to be employed, a Haar (for simplicity) or Daubechies (for accuracy) wavelet may be chosen.

In another possible implementation of the method of the first aspect, the primary channel is selected (rather than being fixedly pre-determined) from the two or more image channels. Due to the processing of images on a patch basis or multiple image basis regions of an image or video sequence can be processed, differently and, particularly, the selection of the primary channel can suitably be changed. Since the content within the image and/or within the video sequence can vary, it may be advantageous for the image modification/enhancement to adapt the primary channel accordingly.

According to another implementation, the secondary channel can also be selected from the two or more image channels. Flexibility of the processing is enhanced by providing this additional selection option.

If at least one secondary channel is selected, exactly one primary channel may be selected. If flags in an encoded stream indicate that other channels of the two or more channels are not to be processed there may be no need to label the selected channels as primary or secondary ones.

According to another implementation, the primary channel and the secondary channel can be selected from the two or more image channels based on an output of a classifier operating based on another neural network. Using a classifier enables training or designing such a classifier in order to properly select the image channel to be the primary channel so that the quality of image modification (such as image enhancement) may be improved.

In principle, the method according to the first aspect is suitable for processing primary and secondary channels of the same size and of different sizes. When the primary channel and the secondary channel are of the same size, according to an implementation, the processing of the transformed secondary channel based on the transformed primary channel comprises concatenating a second three-dimensional tensor representing the transformed secondary channel with a first three-dimensional tensor representing the transformed primary channel. The concatenation is performed along the first non-spatial dimension of the tensors. The spatial dimensions of the tensors are the height and width dimensions of the image region. The first non-spatial dimension results from the spatial frequency transform. For example, if a Discrete Wavelet Transform is used for the spatial frequency transformation the first non-spatial dimension of the tensors is given by the spatial low-frequency sub-band LL and the spatial high-frequency sub-bands HL (vertical features), LH (horizontal features) and HH (diagonal features).

Such a concatenation in order to use the auxiliary information in the image modification process can be relatively fast and memory efficiently performed.

The size of the primary channel can be larger than the size of the secondary channel (thus, being superior in resolution). In this case, according to an implementation, the transformed primary channel is processed based on at least one additional first spatial frequency transform (the first spatial frequency transform and the additional first spatial frequency transform form a cascaded spatial frequency transform) to obtain an auxiliary transformed primary channel of the same size as the transformed secondary channel in a height and in a width direction of the image region. In this case, the processing of the transformed secondary channel is based on the auxiliary transformed primary channel. If, on the other hand, the size of the secondary channel is larger than the size of the primary channel, according to an implementation, the transformed secondary channel is processed based on at least one additional second spatial frequency transform (the second spatial frequency transform and the additional second spatial frequency transform form a cascaded spatial frequency transform) to obtain an auxiliary transformed secondary channel of the same size as the transformed primary channel in a height and in a width direction of the image region. In this case, the processing of the transformed secondary channel comprises processing of the auxiliary transformed secondary channel based on the transformed primary channel.

In both cases, the cascaded transform allows for the processing channels of different sizes without drastically increasing the processor load and processing time. Further, concatenation in order to use the auxiliary information in the image modification process can also be used for processing of channels of different sizes due to the cascaded transform. Thus, the processing of the transformed secondary channel based on the transformed primary channel according to the method of the first aspect according to an implementation comprises concatenating a second three-dimensional tensor representing the transformed secondary channel with a first three-dimensional tensor representing the auxiliary transformed primary channel, if the size of the primary channel is larger than the size of the secondary channel and, on the other hand, concatenating a second three-dimensional tensor representing the auxiliary transformed secondary channel with a first three-dimensional tensor representing the transformed primary channel, if the size of the secondary channel is larger than the size of the primary channel.

In many applications, the primary channel (if any) will have the larger size but this is not necessarily the case. For example, in the case of a combination of a low-resolution grayscale camera and a high-resolution noisy color camera, the low resolution channel of the low-resolution grayscale camera could be selected as the primary channel that, accordingly, would have a lower size than the secondary channel provided by the high-resolution noisy color camera.

It is noted that, in general, the overall processing might be facilitated by restricting the image region to the shape of is a square region in the height and width dimensions of the image region. According to an embodiment, splitting of an image into image regions comprising the image region and padding image regions resulting from the splitting that are not square in the height and width dimensions of the image regions such that they are square in the height and width dimensions of the image region is performed. Alternatively, splitting an image into image regions comprising the image region and if the image cannot be split only into image regions that are square in the height and width dimensions of the image regions, padding the image such that the image is split into image regions only that are all square in the height and width dimensions of the image regions comprising the image region is performed.

Furthermore, it is noted that before being subject to the respective spatial frequency transforms the primary and secondary channels may be subject to pixel shift as described in the detailed description below. Pixel shift may further increase the processing efficiency. In this case, the modified channels after inverse obtained by the inverse spatial frequency transforms are subject to pixel un-shift.

In some exemplary implementations, the method further includes choosing a minimum size for the image region based on the number of hidden layers of the neural network, wherein the minimum size is at least 2*((kernel_size−1)/2*n_layers)+1, with kernel_size being the size of the kernel of the neural network which is a convolutional neural network and n_layers being the number of the layers of the neural network.

Such lower bound for selection of the patch size enables, depending on the design of the neural network, to fully utilize the information of the processed image without adding redundancies by padding or the like.

According to an embodiment (combinable with any preceding or following embodiments and examples, the method further includes rearranging the pixels of each of the at least two image channels of the image region into a plurality, S, of sub-regions wherein: each of the sub-regions of an image channel among the at least two image channels contains a subset of the samples of said image channel, for all image channels, the horizontal dimensions of sub-regions are the same and equal to an integer multiple mh of the greatest common divisor of the horizontal dimension of the image, and for all image channels, the vertical dimensions of sub-regions are the same and equal to integer multiple mv of the greatest common divisor of the vertical dimension of the image.

With such rearrangements, the neural networks may be used to process images of which the image channels differ in dimension/resolution.

In particular, the S sub-regions of the image region are disjoint with S=mh*mv, and have horizontal dimension dimh and vertical dimension dimv, and a sub-region includes samples of the image region on the positions {kh*mh+offh, kv*mv+offv}, with kh∈[0, dimh−1] and kv∈[0, dimv−1], and each combination of offh and offv specifies the respective sub-region with offk∈[1, mh] and offv∈[1, mv].

With the above-mentioned determination of patch size, it is possible to utilize the image and to effectively adapt the patch size to the dimensions of the image for each channel, even when the channels differ from each other in resolution and/or dimensions (vertical and/or horizontal).

As already mentioned the first and second neural networks may be operated independently of each other. According to an implementation, weights (and activation functions) of one of the first and second neural networks are determined and used independent from weights of the other one of the first and second neural networks. Individual adaption of one of the networks does not affect the configuration of the other one.

According to second aspect, a method is provided for encoding an image or a video sequence or images including: obtaining an original image region, encoding the obtained image region into a bitstream, and applying the modifying an image region obtained by reconstructing the encoded image region as mentioned above.

Employing the image modification in image or video coding enables improvement of the quality of the decoded images. This may be a quality in the sense of distortion which may be reduced. However, for some applications, there may be some special effects which may be desired and the modification may lead to their improvement (which does not necessarily reduce the distortion with regard to the original picture).

For example, the encoding may comprise a step of including into the bitstream an indication of the selected primary channel. This enables possibly better reconstruction at the decoder side; better in terms of distortion with respect to the original (not distorted) image.

According to an exemplary implementation, the method further comprises including into the bitstream an adaption of one or more weights of at least one of the first and second neural network weights.

According to an exemplary implementation, the method further includes obtaining a plurality of image regions, applying said method for modifying the obtained image region to the image regions of the obtained plurality of image regions individually, including into the bitstream for each of the plurality of image regions at least one of: an indication indicating that the method for modifying the obtained image region is not to be applied for the image region, an adaption of the one or more weights of at least one of the first and second neural networks, or an indication of the selected primary channel for the region. Region based processing facilitates adaption to the image or video content.

When applying the method for modifying the obtained image region, the selection of the primary channel and the secondary channel may be performed based on the reconstructed image region without referring to the obtained image region input to the encoding step. This avoids additional overhead (rate requirements). According to third aspect, a method is provided for decoding an image or a video sequence or images from a bitstream including reconstructing an image region from the bitstream; and applying the method for modifying the image region as described above.

Application of the image or video modification at the decoder side may improve the decoded image quality.

The method for decoding the image or the video sequence in some embodiments includes: parsing the bitstream to obtain at least one of: an indication indicating that the method for modifying the obtained image region is not to be applied for the image region, an indication of the selected primary channel for the region, an adaption of one or more weights of at least one of the first and second neural networks, reconstructing an image region from the bitstream, and in a case where the indication indicates a selected primary channel, modifying the reconstructed image region with the indicated primary channel as the selected primary channel.

Reconstruction based on side information may provide better performance in terms of quality as mentioned above for the corresponding encoding method. The modification may be applied as in-loop filter or as post-processing filter at the encoder and/or the decoder.

According to an exemplary implementation, the method further includes: in case an adaption of weights of at least one of the first and second neural network is present in the bitstream, modifying the weights of the respective neural network accordingly.

According to a fourth aspect, it is provided a computer program product comprising a program code stored on a non-transitory medium, wherein the program, when executed on one or more processors, performs the method according to any one of the above-described aspects and implementations.

According to a fifth aspect, it is provided an apparatus for modifying an image region represented by two or more image channels, comprising circuitry configured to perform steps according to the method according to any one of the above-described aspects and implementations. The apparatus provides technical means for implementing an action in the method defined according to the first aspect. The function may be implemented by hardware, or may be implemented by hardware executing corresponding software.

According to a sixth aspect, it is provided an apparatus for modifying an image region represented by two or more image channels, comprising a first spatial frequency transform unit configured for processing a primary channel of the two or more image channels to obtain a transformed primary channel and a second spatial frequency transform unit configured for processing a secondary channel of the two or more image channels different from the primary channel to obtain a transformed secondary channel. Further, the apparatus comprises a first neural network configured for processing the transformed primary channel to obtain a modified transformed primary channel and a second neural network configured for processing the transformed secondary channel based on the transformed primary channel to obtain a modified transformed secondary channel. Furthermore, the apparatus comprises a first inverse spatial frequency transform unit configured for processing the modified transformed primary channel to obtain a modified primary channel and a second inverse spatial frequency transform unit configured for processing the modified transformed secondary channel to obtain a modified secondary channel as well as a combining unit configured for obtaining a modified image region based on the modified primary channel and the modified secondary channel.

Further features and implementations of the method according to the first aspect of the present disclosure correspond to respective possible features and implementations of the apparatus according to the sixth aspect of the present disclosure. The advantages of the apparatus according to the sixth aspect can be the same as those for the corresponding implementations of the method according to the first aspect.

According to a seventh aspect, it is provided an encoder for encoding an image or a video sequence or images, wherein the encoder comprises an input module for obtaining an original image region, a compression module for encoding the obtained image region into a bitstream, a reconstruction module for reconstructing the encoded image region, and one of the above-mentioned apparatuses for modifying the reconstructed image region according to the fifth and sixth aspect, respectively.

According to an eight aspect, it is provided decoder for decoding an image or a video sequence or images from a bitstream, wherein the decoder comprises a reconstruction module for reconstructing an image region from the bitstream and the apparatus for modifying the reconstructed image region according to the fifth and sixth aspect, respectively.

According to a ninth aspect, the present disclosure relates to a video stream decoding apparatus, including a processor and a memory. The memory stores instructions that cause the processor to perform the method according to the first aspect and its implementations.

According to a tenth aspect, the present disclosure relates to a video stream encoding apparatus, including a processor and a memory. The memory stores instructions that cause the processor to perform the method according to the first aspect and its implementations.

According to a eleventh aspect, a computer-readable storage medium having stored thereon instructions that when executed cause one or more processors to encode video data is proposed. The instructions cause the one or more processors to perform the method according to the first or second aspect or any possible embodiment of the first aspect and its implementations.

The above mentioned apparatuses may be embodied on an integrated chip.

Any of the above-mentioned embodiments and exemplary implementations may be combined with each other as it is considered suitable.

### BRIEF DESCRIPTION OF DRAWINGS

In the following embodiments of the invention are described in more detail with reference to the attached figures and drawings, in which:

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture wherein an encoder and a decoder side include a hyperprior model;

FIG. 3B is a schematic drawing illustrating a general network architecture wherein an encoder side includes a hyperprior model;

FIG. 3C is a schematic drawing illustrating a general network architecture wherein a decoder side includes a hyperprior model;

FIG. 4 is a schematic drawing illustrating an exemplary network architecture wherein an encoder and a decoder side include a hyperprior model;

FIG. 5 is a block diagram illustrating a structure of a cloud-based solution for machine based tasks such as machine vision tasks;

FIG. 6 is a block diagram illustrating end-to-end video compression framework based on a neural networks;

FIG. 7 is a schematically drawing of collaborative processing of three-color channels by a convolutional neural network;

FIG. 8 is a schematically drawing of collaborative processing of n-channels by a convolutional neural network;

FIG. 9 is a schematically drawing of DWT based collaborative processing of n-channels by neural networks according to an embodiment;

FIG. 10 is a schematically drawing of DWT based collaborative processing of n-channels of different sizes by neural networks according to an embodiment;

FIG. 11 illustrate a neural network involved in DWT based collaborative processing of n-channels according to an embodiment;

FIG. 12 is a flow diagram illustrating an exemplary method of modifying an image region;

FIG. 13 shows an exemplary apparatus for modifying an image region;

FIG. 14 is a block diagram showing an example of a video coding system configured to implement embodiments of the present disclosure;

FIG. 15 is a block diagram showing another example of a video coding system configured to implement embodiments of the present disclosure;

FIG. 16 is a block diagram illustrating an example of an encoding apparatus or a decoding apparatus; and

FIG. 17 is a block diagram illustrating another example of an encoding apparatus or a decoding apparatus.

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and frameworks within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and to use the results to identify cats in other images. They do this without any prior knowledge of cats, for example, that they have furs, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically each have a weight that adjusts as learning proceeds. The weight increases or decreases the strength of the signal at a connection. Neurons may have thresholds such that a signal is sent only if the aggregate signal crosses that threshold. Typically, neurons are aggregated into layers. Different layers may perform different transformations on their inputs. Signals travel from the first layer (the input layer) to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

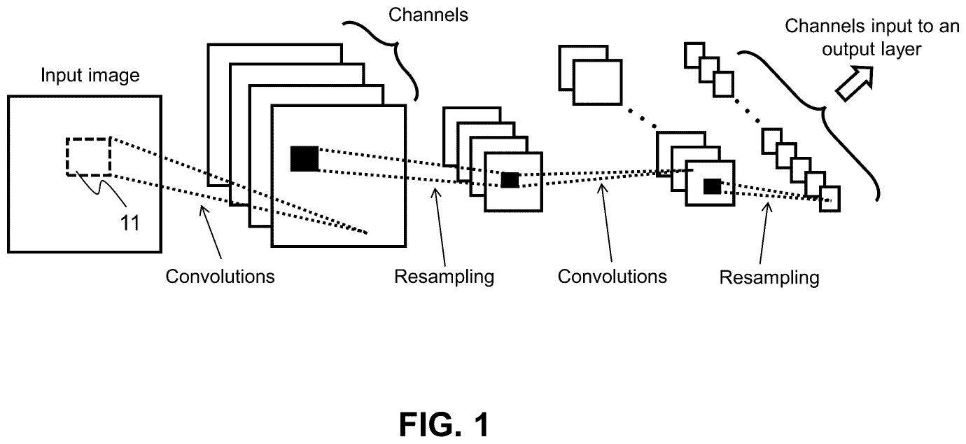

FIG. 1 schematically illustrates a general concept of processing by a neural network such as the CNN. A convolutional neural network consists of an input and an output layer, as well as multiple hidden layers. An input layer is the layer to which the input (such as a portion 11 of an input image as shown in FIG. 1) is provided for processing. The hidden layers of a CNN typically consist of a series of convolutional layers that convolve with a multiplication or other dot product. The output of a layer is one or more feature maps (illustrated by empty solid-line rectangles), sometimes also referred to as channels. There may be a resampling (such as subsampling) involved in the operation of some or all of the layers. As a consequence, the feature maps may become smaller, as illustrated in FIG. 1. It is noted that a convolution with a stride may also reduce the size (resample) of an input feature map. The activation function in a CNN is usually a ReLU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutional ones, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with dimensions (number of images)×(image width)×(image height)×(image depth). It should be known that the image depth can be constituted by channels of an image. After passing through a convolutional layer, the image becomes abstracted to a feature map, with dimensions (number of images)×(feature map width)×(feature map height)×(feature map channels). A convolutional layer within a neural network should have the following attributes; Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to be feasibly processed efficiently at scale with full connectivity. Also, such network architecture does not take into account the spatial structure of data, treating input pixels which are far apart from each other in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when they detect some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favor compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which an output size is fixed and an input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

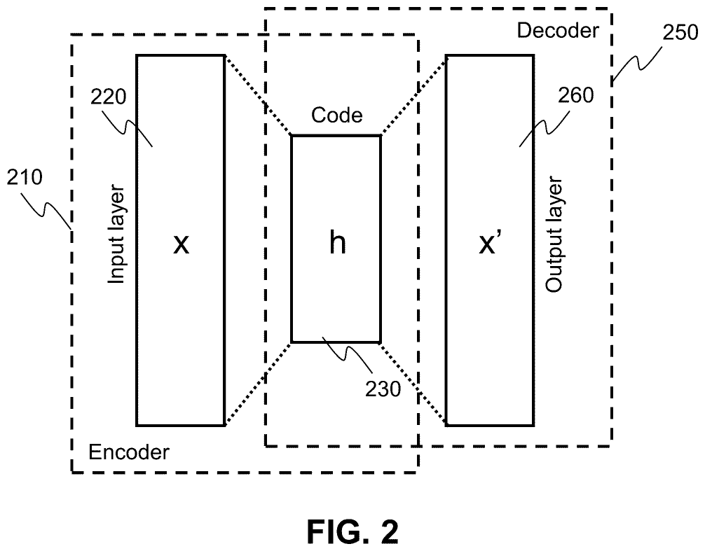

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( W x + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{K L} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

$$\begin{matrix}{q}_{ϕ} ( h \vert x ) = 𝒩 ( ρ ( x ) , {ω}^{2} ( x ) I ) \\ {p}_{ϕ} ( x \vert h ) = 𝒩 ( μ ( h ) , {σ}^{2} ( h ) I )\end{matrix}$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representations to code a residual signal after prediction. Several transforms are used for that purpose such as discrete cosine and sine transforms (DCT, DST), as well as low frequency non-separable manually optimized transforms (LFNST).

### Variational Image Compression

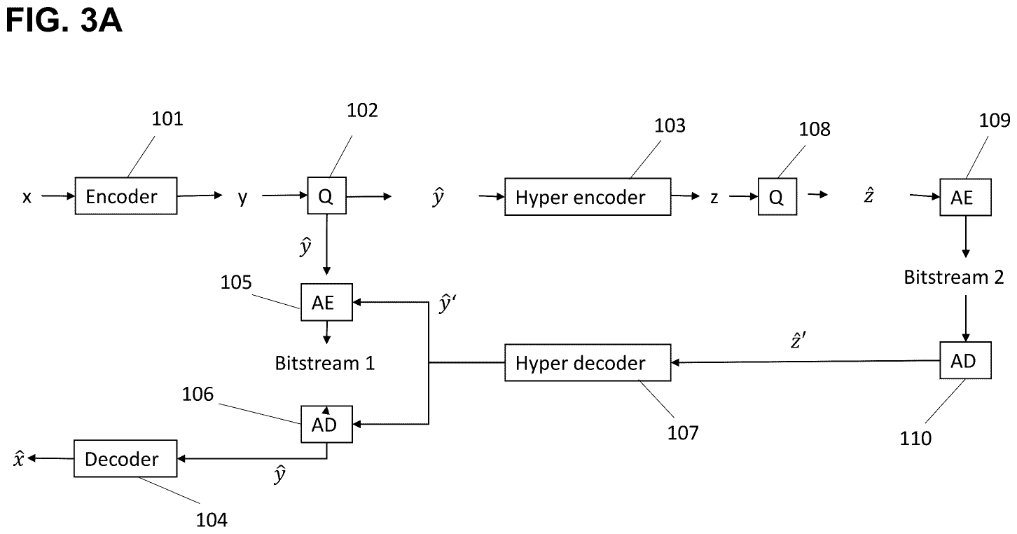

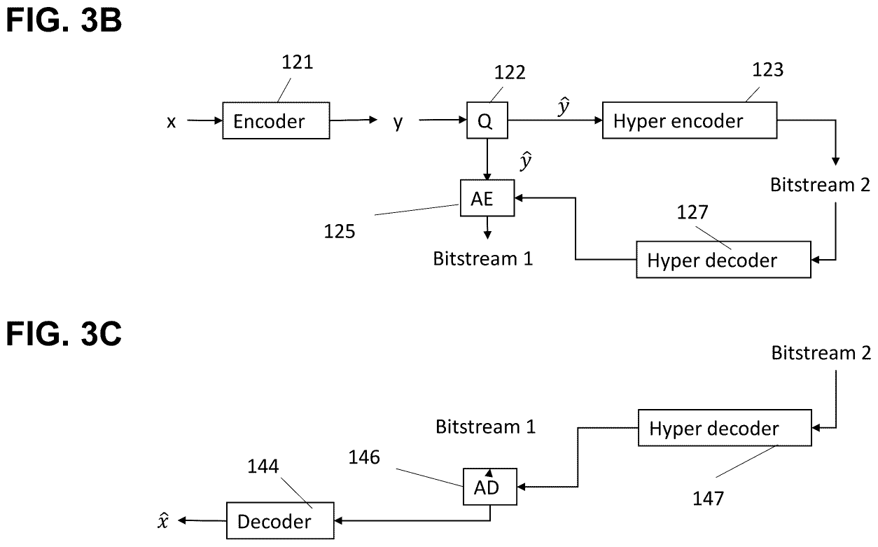

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream 1 and bitstream 2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might, for example, comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream 1”. The second network in FIG. 3A comprises modules 103, 108, 109, 110 and 107 and is called “hyper encoder/decoder” subnetwork. The second subnetwork is responsible for generating the second bitstream “bitstream 2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,”.
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream 1”, such that the compressing of bitstream 1 by first subnetwork is more efficient. The second subnetwork generates a second bitstream “bitstream 2”, which comprises said information (e.g. mean value, variance and correlations between samples of bitstream 1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream 2. In this example, the binarization is performed by an arithmetic encoding (AE). A decoding part of the second network includes arithmetic decoding (AD) 110, which transforms the input bitstream 2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream 1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for decoding, for example. It is noted that the components of the encoder and decoder denoted with numerals 12x and 14x may correspond in their functions to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream 1. The bitstream 1 and bitstream 2 are the output of the encoding of the signal, which are then provided (transmitted) to the decoding process. Although the unit 101 (121) is called “encoder”, it is also possible to call the complete subnetwork described in FIG. 3B as “encoder”. Encoder in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The authors optimize for Mean Squared Error (MSE), but use a more flexible transforms built from cascades of linear convolutions and nonlinearities. Specifically, the authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

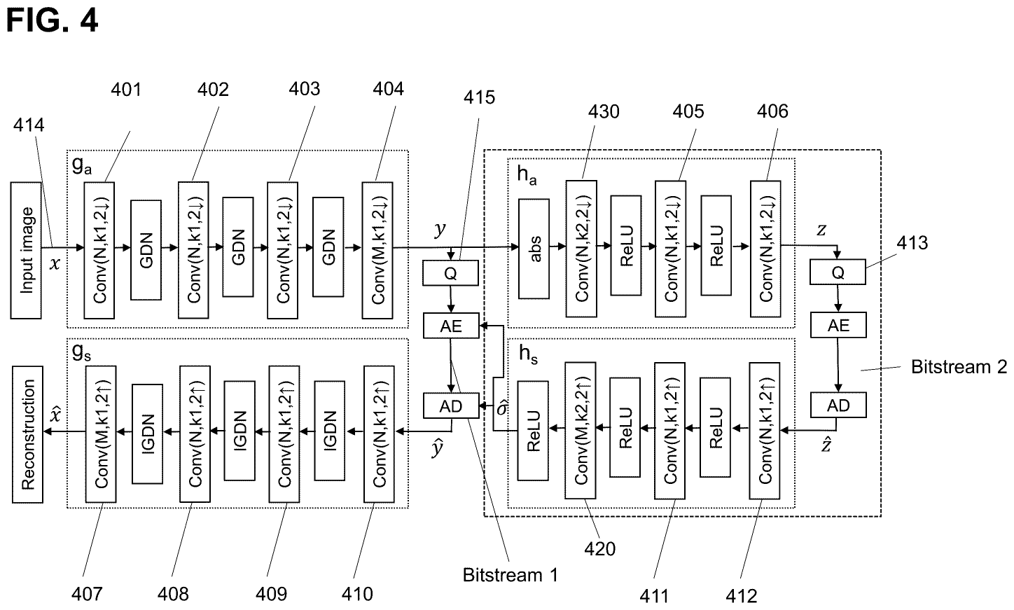

Such an example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE and AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover y as well. It then feeds ŷ into gₛ to obtain the reconstructed image.

The layers that include downsampling are indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream 2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

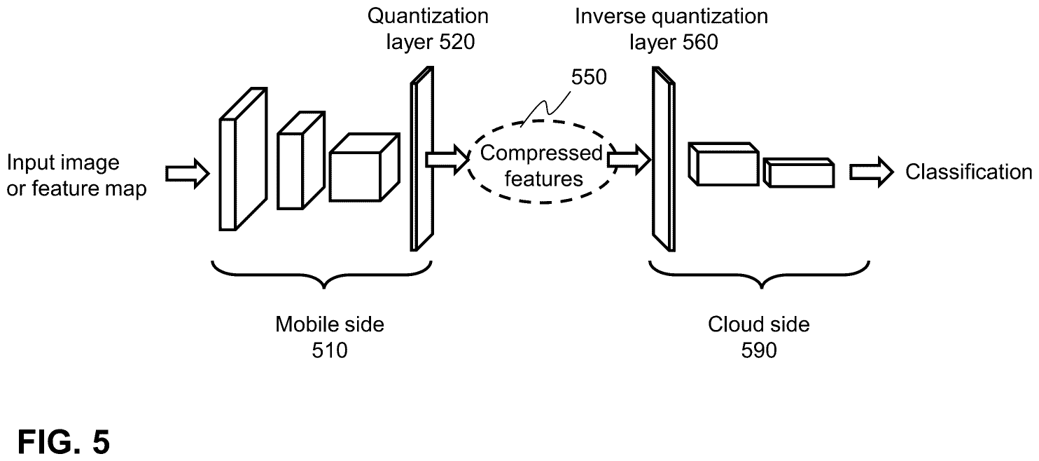

The Video Coding for Machines (VCM) is another computer science direction being popular nowadays. The main idea behind this approach is to transmit a coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm wherein processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

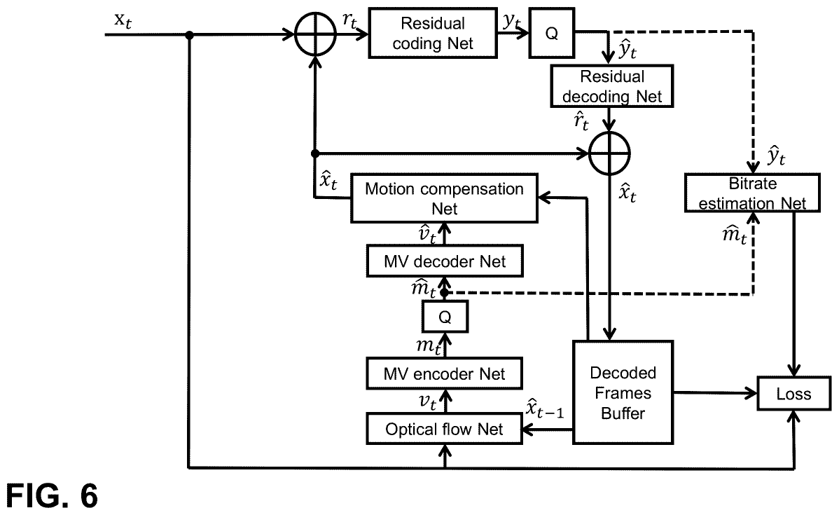

Such encoder is illustrated in FIG. 6. In particular, FIG. 6 shows an overall structure of end-to-end trainable video compression framework. In order to compress motion information, a CNN was designated to transform the optical flow vₜ to the corresponding representations mₜ suitable for better compression. Specifically, an auto-encoder style network is used to compress the optical flow.

In general, video compression may decrease the perceived quality of an image, and an image enhancement filter may generally be used to improve the output quality of compressed video.

One type of image enhancement filters are improving the quality of a multichannel image by exploiting similarities between the channels. The performance of a multichannel image enhancement algorithm varies with some parameters of the input multichannel image (e.g. number of channels, their quality) and also varies across the image data in each channel.

Various image enhancement algorithms exist. Only a few of them utilize inter-channel correlation information for image enhancement. In the present disclosure, focus is put on multichannel image enhancement filters, which use neural networks, such as convolutional neural networks. In neural network based enhancement filters, a network is trained with two sets of images-one represents the original (target, desired) quality, and the other represents the range and types of the expected distortions. Such network can be trained to improve images impaired e.g. by sensor noise, or images impaired by video compression, or by other kinds of distortion. Usually, different (individual and separate) training is required for each distortion type. A more general network (e.g. handling a larger range and type of distortions) has a lower average performance. Here, the performance refers e.g. to quality of reconstruction which may be measured by objective criteria such as PSNR or by some metrics which also consider human visual perception.

In some embodiments of the present application, a deep convolutional neural network (CNN) is trained to reduce compression artifacts and enhance the visual quality of the image while maintaining the high compression rate. In particular, according to an embodiment, a method is provided for modifying an input image region. Here, modifying refers to any modification such as modifications obtained typically by filtering or other image enhancement approaches. The type of modification may depend on a particular application.

One of networks which yields good results for a wide range of distortions without needing to be trained for each specific case is known from Cui, Kai & Steinbach, Eckehard. (2018): “Decoder Side Image Quality Enhancement exploiting Inter-channel Correlation in a 3-stage CNN” Submission to CLIC 2018, IEEE Conference on Computer Vision and Pattern Recognition (CVPR) Workshops, June 2018. Therein, a three-stage convolutional neural network (CNN) based approach is proposed, which can exploit the inter-channel correlation to enhance image quality at the decoder side.

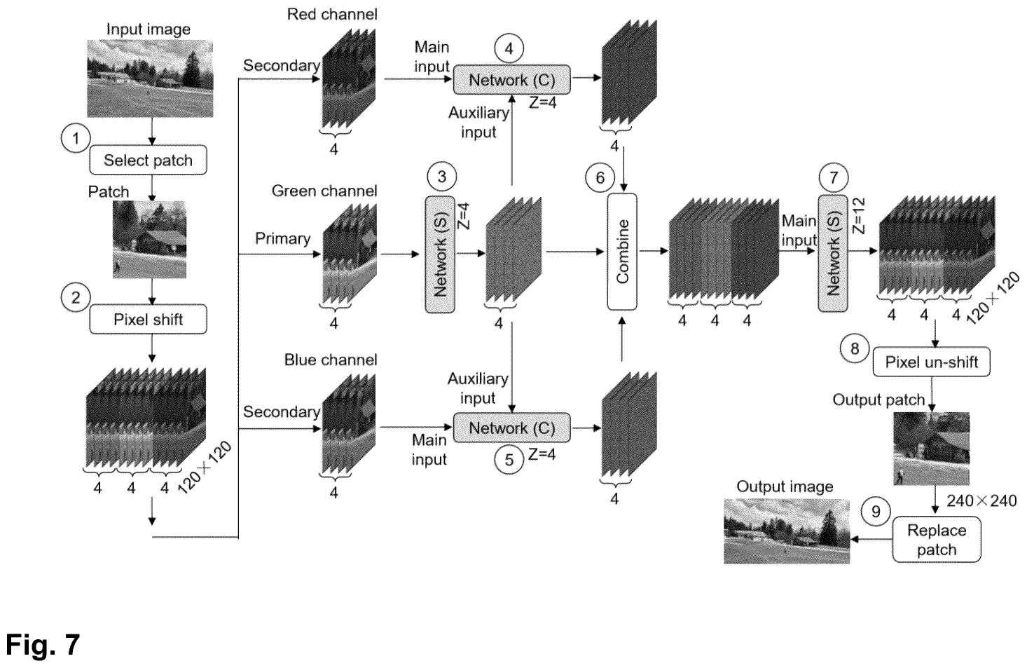

FIG. 7 illustrates such three-channel CNN framework. CNN is a neural network, which employs a convolution in place of a general matrix multiplication in at least one of their layers. Convolutional layers convolve the input and pass its result to the next layer. They have some beneficial features in especially for image/video processing. The CNN of FIG. 7 is described and the applied stages are explained including the known arrangement as well as possible arrangements and alternatives which may facilitate application of the CNN in some embodiments of the present disclosure.

The input image is stored in an RGB (red, green, blue) format (color space). The input image may be a still image or it may be an image, which is a frame of a video sequence (motion picture).

Numbers in circles in FIG. 7 denote stages of processing. At stage 1, a patch is selected from the input image. In a particular example, the patch has a predetermined size, such as the size of 240×240 samples (pixels). The patch size may be fixed, or may be predetermined. For example, the patch size may be a parameter which may be configurable by a user, or an application, or conveyed within a bitstream and set accordingly, or the like. The selection of the patch size may be performed depending on the image size and/or on the amount of detail in the image.

The term “patch” here refers to a part of the image which is processed by filtering and the processed part is then pasted back in the position of the patch. Patch may be regular, such as rectangular or square. However, the present disclosure is not limited thereto and the patch may have any shape, such as a shape following the shape of a detected/recognized object, which is to be filtered. In some embodiments, the entire image is filtered (enhanced) patch by patch. In other embodiments, only selected patches (e.g. corresponding to objects) may be filtered while the remaining parts of the image are not filtered or filtered by another approach. By filtering, any kind of enhancement is meant.

The selection may be a result of sequential or parallel processing in which all patched are filtered. In such case, the selection may be performed in a predetermined order such as from left to right and from top to bottom. However, the selection may also be performed by a user or an application and may only regard a part of the image. A patch may be continuous or may be distributed.

In case the entire image is divided into patch areas, padding may be applied it an integer multiple of the patch dimensions (vertical or horizontal) does not match the image size. The padding may include mirroring of the image portions which are available over an axis formed by the image boundary (horizontal or vertical) to achieve the size which fits an integer number of patches. More particularly, the padding is performed so that the vertical dimension (number of samples after padding) is an integer multiple of the vertical patch dimension. Moreover, the horizontal dimension (number of samples after padding) is an integer multiple of the horizontal patch dimension.

Then, the image enhancement may be performed by sequentially or in parallel selecting and processing each of the patches. The patches may be non-overlapping as suggested above. However, they may be also overlapping, which may improve quality and reduce possible boundary effects between separately processed patches.

In stage 2, the pixels of the patch are re-ordered for easier processing. The re-ordering may include so called pixel-shifting. The pixel shift reorders the pixels in each channel, so that a channel with dimensions N×N×1 is transformed to a 3D-array with dimensions N/2×N/2×4 (here, the symbol “×” stands for “times”, i.e. for multiplication). This is performed by subsampling the channel where a single value is taken from each non-overlapping block of 2×2 values. The first layer of the 3D array is created from the top-left values, the second layer from the top-right, the third from the bottom-left values, and the fourth from the bottom-right values. At the end of the pixel shift operation, a 3-channel RGB patch with size N×N pixels becomes a stack (3D-array) with dimensions N/2×N/2×4. This pixel shifting is mainly done for computational reasons—it is easier for a processor (such as a graphical processing unit, GPU) to process narrow and deep stacks rather than wide and shallow ones. It is noted that the present disclosure is not limited to subsampling by 4. In general, there may be subsampling by more or less resulting in corresponding stack depth of more or less resulting subsampled images.

In stage 3 of FIG. 7, the green channel is processed in a single-channel mode. In this example of FIG. 7, it is assumed that the green channel is the primary channel and the remaining channels are secondary channels. It is assumed that distortion of each channel is strongly correlated with the channel color. It is assumed that the green channel is the one with the least distortion. On average, this may be a fair guess for an RGB image affected by sensor noise or compression, as RGB images are captured using a RGGB sensor pattern (Bayer pattern), capturing more green samples than red and blue samples. However, according to the present disclosure, as will be discussed below, the green channel is not necessarily the best and it may be advantageous to perform channel selection. Moreover, channels other than color channels may be used and may provide higher quality information.

In FIG. 7, the primary (i.e. green) channel is processed alone in stage 3. The red channel is processed together with the improved green channel (stage 4). The Blue channel is processed together with the improved green channel (stage 5). The Improved red, green, and blue channels are then stacked (combined) together (stage 6) and are processed with no side information or with side information.

Overall, the framework has four NNs stages—stages 3, 4, 5, and 7 in FIG. 7. Stages 3 and 7 input a single 3D-array of values and output a 3D-array with the same size as the input. Stages 4 and 5 input two 3D-arrays, one main and one auxiliary. The output is with the same size as the main output, and is intended to be a processed (e.g. enhanced) version of the main input, while the auxiliary input is used only to aid the processing and is not outputted.

In stage 4, the final hidden layer is processed by N convolution kernels 3×3×64, and outputs the stack with size Z. In stage 5, the input is added to the processed output, as the network is trained to approximate the difference between the input and the desired output.

In stage 5 of FIG. 7, the blue channel is processed collaboratively with the enhanced green channel. The processing is similar to the processing described with reference to the red channel and FIG. 7.

It is noted that in the present disclosure, the term “channel” or “image channel” does not necessarily refer to a color channel. Other (tensor) channels such as a depth channel or other feature channel may be enhanced using the embodiments described herein.

In stage 6 of FIG. 7, all processed channels (red, green, blue) are combined into Z=12 (4 sub-sampled images per color channel) images of the size 120×120. Here, the combination means stacking together, as a common input for the next stage 7. In stage 7, the combined channels are processed together by the Network(S).

In stage 8, the pixels are re-ordered back to form the processed patch. This may include removing the padding by cropping the mirrored portions. It is noted that the above-mentioned padding by mirroring is only one of possibilities how to perform the padding. The present disclosure is not limited to such specific example.

In stage 9, the processed patch is inserted back to the original image. In other words, the original image is updated by the enhanced patch. During the training procedure, a set of original and distorted images are used as input, and all convolution kernels of all 4 networks are selected. The aim of the network is to get a distorted image and produce a close match to the original image.

CNN-based multichannel enhancement filter as described above works in a rigid, non-adaptive way—the processing parameters are setup during the design (or training) of the filter, and are applied in the same way regardless of the content of the image passing through the filter. However, an optimal selection of the primary channel can vary from image to image or even for parts of the same image. For the image enhancement quality it is advantageous if the primary (leading) channel is the channel which has the highest quality, meaning the lowest distortion. This is because the primary channel is involved also in the enhancement of the remaining channels. The inventors recognized that by carefully choosing the primary channel for each patch or each image or the like a better performance may be achieved, which has been confirmed by experiments. Secondly, the enhancement performance (of all enhancement filters) varies with the image quality of the input. It works optimally for a range of distortion strengths, and does not provide much improvement for some very high or very low distortion levels. This is because a high quality input can barely be improved more and a low quality input is too distorted to be reliably improved. As a consequence, for some inputs it is beneficial to skip the enhancement processing altogether. Thirdly, the above mentioned (cf. FIG. 7) image enhancement is designed for an RGB input, where the resolution of all three channels is identical. However, in some video standard formats (e.g. YUV 4:2:0 or YUV 4:2:2 or the like) different channels may have different resolutions and number of pixels. It is noted that the image modification as described herein is not necessarily applied during encoding or decoding. It may be used also in pre-processing. For example, it may be used to enhance image or video in the raw format, such as a Bayer pattern based format. In other words, the modification of image may be applied to any images or videos.

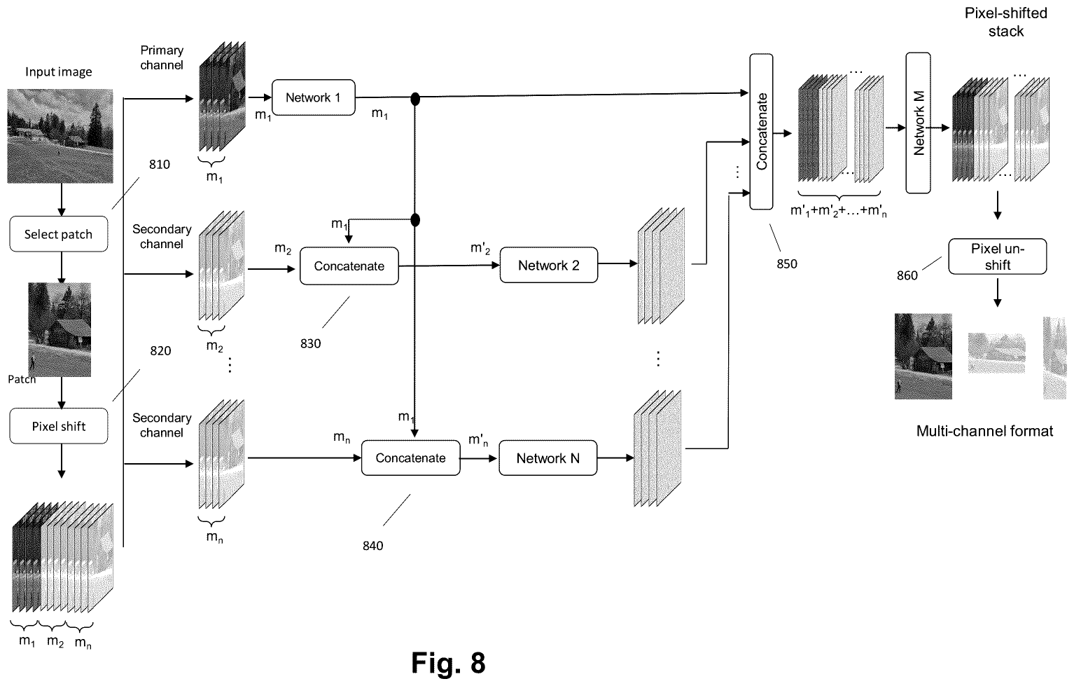

The above-mentioned issues are addressed in WO 2021 249684 A1 that provides an image enhancement filter capable of adapting to different input formats and different contents, multichannel image formats with arbitrary number of channels (for example, n channels as illustrated in FIG. 8) and different number of pixels in each channel and having a content analysis module added in order to tune the filter to process the input channels in a particular order, or to skip processing altogether. Particularly, the primary channel can be selected, for example, based on content analysis. The configuration shown in FIG. 8 allows for processing n channels. After selection 810 of a patch of an image to be processed, pixel shift applied 820 to the selected patch and selection of the primary channel the primary channel is processed by Network 1 and the thus obtained modified primary channel is used as auxiliary information when processing the secondary channels. The output m′₁ of Network 1 is concatenated 830, 840 with the 3D arrays of the secondary channels m₂ to mₙ and the resulting concatenated 3D arrays m_{2c} to m_{nc} are processed by Network 2 to Network N, respectively. The outputs of the Network 1 to Network N are concatenated 850, m′₁+m′₂+ . . . +m′ₙ, and processed by Network M. The output of the Network M is pixel un-shifted 860 to obtain the enhanced multichannel image region.

Different from the art, in the present disclosure spatial frequency transform based image modification (for example, enhancement) using inter-channel correlation information is provided. The spatial frequency transform provides information on spatial frequencies but not necessarily only on spatial frequencies (for example, wavelet transforms also provide information on location).

Suitable spatial frequency transforms that might be employed include a wavelet transform (Discrete Wavelet Transform, DWT, or Stationary Wavelet Transform), a Discrete Fourier Transform, a Fast Fourier Transform and energy compacting transforms comprising a Discrete Cosine Transform.

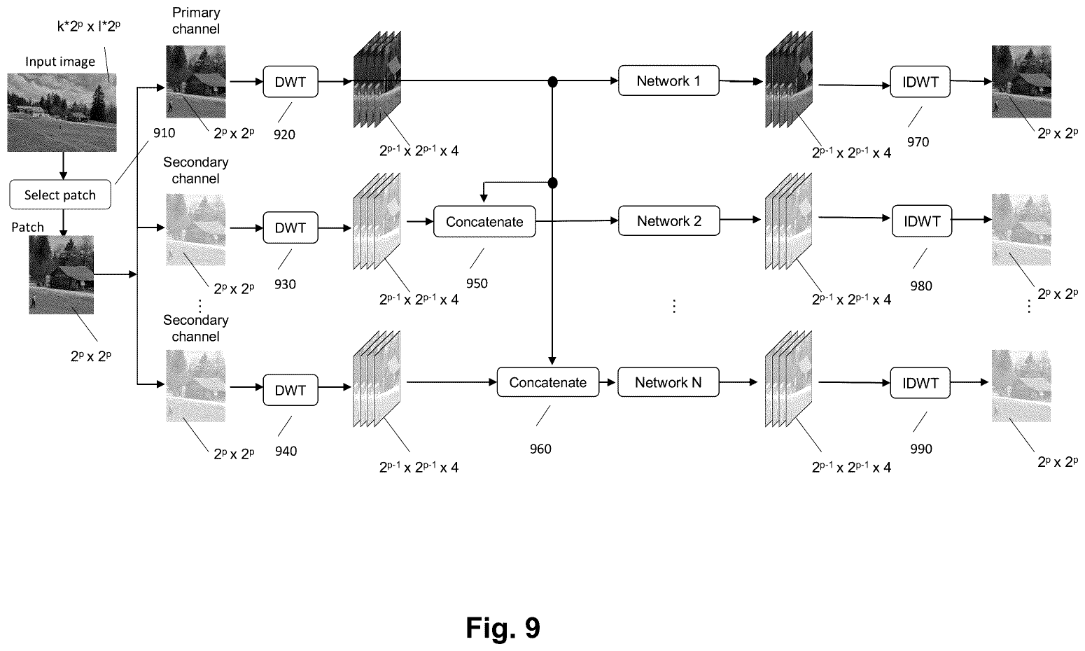

A particular embodiment is illustrated in FIG. 9. This and other embodiments represent tuneable enhancement filters that can adapt to different input formats and different content and can process multichannel image formats with an arbitrary number of channels and different number of pixels in each channel. Channels representing an image region that is to be processed can be any feature channels that are considered appropriate, for example, color channels, and may have any sizes (depths), for example, different sizes.

For a provided (distorted) input image, a patch (or image region) to be processed is selected 910. It is noted that selection of the patch does not necessarily mean that there is some intelligence in selecting the patches. Rather, the selection may be done according to a sequential processing (e.g. in a loop) or may be performed for two or more patches (or even all patches) at once, for example, when parallel processing is applied. The selection step merely corresponds to determining which patch is to be processed. For a size of the image of k·2^{p}×1·2^{p} (in the height and width dimensions) with integers k, 1 and p the image is split into k×1 square patches each having the size 2^{p}×2^{p}. If the image cannot be split into k×1 square patches, it is padded before splitting. Alternatively, the image is split into patches and if patches resulting from the splitting are not square in the width and height dimensions they are is padded in order to obtain square patches. Depending on the image modification kind, there may be some criteria which are advantageously observed when choosing the patch size (size of the image region which is modified). In particular, there may be some minimum size given by the type of processing applied during the image modification (for details see WO 2021 249684 A1).

The input image may be a still image or a part of a video sequence. The patch with dimension 2^{p}×2^{p} that is to be processed is split into (distorted) channels, for example, color channels as RGB or YUV (luminance and chroma) channels (components). One of the channels is selected as a primary channel (for example luma in the case of YUV channels). The other channels are secondary channels that are processed based on information related to the primary channel. The channels have sizes 2^{p}×2^{p} wherein the integer p has not to be the same for each of the channels, i.e., different sample resolutions may be provided for the different channels. In the embodiment illustrated in FIG. 9, p is the same for all of the channels, for example, for processing a YUV 444 image (patch). If the channels are YUV channels, the Y channel may be selected as the primary channel. Selection of the primary channel may be performed in accordance with the teaching provided in WO 2021 249684 A1. Particularly, the primary channel may be selected based on an analysis, for example, a content analysis of the patches or the selected patch. For example, a classifier based on a neural network or a convolutional neural network may be used for the selection of the primary channel (and the secondary channel). The classifier may be also implemented by some algorithm such as an algorithm determining the level of detail, and/or strength and/or direction of edges, distribution of gradient, movement characteristics (in case of video) or other image features. Based on comparison of such features for the respective image channels, the primary channel may then be selected. For example, as a primary channel, the image channel including most or sharpest edges (corresponding to most details) may be selected.

The selection can be done on the encoder side and signalled to the decoder side, it can be predetermined, or can be performed independently on the encoder side and the decoder side, using image analysis methods performed for the patch. In the two latter cases, the selection of the primary channel is not signalled. Further, it is noted that the selection of a primary channel of a patch can be different for some or each of the patches the image is divided into. Alternatively, a fixed predetermined primary channel may be used.

All channels are processed 920, 930, 940 with a two-dimensional discrete wavelet transform (DWT). Here and in the following, a DWT is employed as an example for the employment of a spatial frequency transform. Other examples as the ones mentioned above might be employed. Any kind of wavelet considered appropriate might be used for the DWT. For example, the Haar wavelet or a Daubechies wavelet may be considered as a suitable choice. Application of a DWT to the pixel values of the pixels of the primary channel 920 results in a DWT transformed primary channel with the size 2^{p-1}×2^{p-1}×4. The third dimension (with size 4) of the three-dimensional array output by the DWT is given by the spatial low-frequency sub-band LL and the spatial high-frequency sub-bands HL (vertical features), LH (horizontal features) and HH (diagonal features). All sub-bands may be arranged in one single matrix (layer) such that the output of a DWT transform is still one single layer or they may be represented by individual layers. Correspondingly, application of DWTs on the pixel values of the pixels of the secondary channels 930, 940 results in DWT transformed secondary channels with the sizes 2^{p-1}×2^{p-1}×4.

The DWT transformed primary channel is processed independently from the DWT transformed secondary channels by a first network Network 1. Further, the DWT transformed primary channel is concatenated 950, 960 (along the third dimension) with each of the DWT transformed secondary channels. Thus, the DWT transformed primary channel is used as auxiliary information for processing of the (DWT transformed) secondary channels. The arrays resulting from the concatenation processes are input in networks Network 2 to Network N, respectively, that operate independently form each other. Network 1 is designed to have input and output of the same sizes (2^{p-1}×2^{p-1}×4). Network 2 to Network N are designed to have input with more (tensor) layers than the output (input of 2^{p-1}×2^{p-1}×8 due to the concatenation processes and output of 2^{p-1}×2^{p-1}×4).

The output of Network 1 is subject to an inverse DWT 970, and the outputs of the networks Network 2 to Network N are also subject to inverse DWTs 980, 990. After application of the inverse DWTs 970, 980, 990 an enhanced primary channel with size 2^{p}×2^{p} and enhanced secondary channels with sizes 2^{p}×2^{p} are obtained and can be combined in order to achieve a modified, for example, an image enhanced (substantially undistorted) patch with size 2^{p}×2^{p}. A next patch may be selected and processed as described above. All processed patches can be assembled to build the reconstructed image, and any padding (if needed) is removed.

The above-described filter comprises N DWT transforms, N neural networks and N inverse DWT transforms. It is, for example, trained to receive distorted (e.g. by compression) images and to output close approximations of the original image. Using the processed (e.g. recovered) primary channel to help the processing (e.g. recovering) of the secondary channels allows the filter to utilize correlation between the channels and achieve good reconstruction with a relatively small number of processing steps. Using of the DWT transform helps with decorrelation of the input data (into high and low spatial frequency components), which helps the network to reach a good performance with less number of parameters and makes it easier to train as compared to the art. During the training process each network learns to take the distorted (e.g. by compression) input and output the best approximation of the original (before distortion) image. This is done by training the network with pairs of distorted (source) and original (target) patches. One common practice is to train with more than one set of distorted images, and thus obtain more than one set of neural network coefficients—each set being optimal for a particular type of content (e.g. computer games, teleconference, etc.) or particular level of distortion (e.g. high compression, medium compression, etc.). During compression, the encoder might analyse the content and select the best set of trained coefficients. This selection might be different for each patch and for each channel—for example, Network 1 might use the “highly compressed computer screen content” set of coefficients, Network 2 might use the “medium compressed teleconference screen content” set and processing by Network N might be turned off and work in “pass through” mode. Also, any of the networks (Network 1 to Network N) can be turned off independently, skipping the processing altogether.

Further, employment of DWT results in a rearrangement of array elements input into the DWT, namely, a quarter of the spatial dimension and 4 layers along the third dimension. In the neural networks that follow the DWT transform convolution is applied in the first two dimensions, which allows a neural network processing unit to process the data efficiently in parallel.

In fact, as compared to the art the overall processing can be speeded up by a factor of more than 5 depending on the actual application.

Furthermore, in the art all channels are combined and then processed together (see network M in FIG. 8). A set of networks is trained and each one is optimized for different contents. It might happen, that the optimal processing setup for a given image comprises to turn off the processing for the primary channel and different setup for each of the secondary channels. In the art, there was the need to run all networks multiple times and assemble the outputs (e.g. take original for channel 1, take version 4 for channel 2, etc.). According to the present disclosure, channel processing can be turned on/off independently and selection/training of weight coefficients can, advantageously, be done for each of the networks/channels independently. Optimal parameter selection usually requires different processing for each one of the channels, for example, three YUV channels. In the art there is a need to run the filter three times (for three channels), each time with the optimal parameters for one of the components, and then combine the desired parts to form the output. According to the present disclosure, a filter has to be run only once, regardless of the filter selection. Coefficients of one of the neural networks can be changed without affecting the output of the other neural networks.

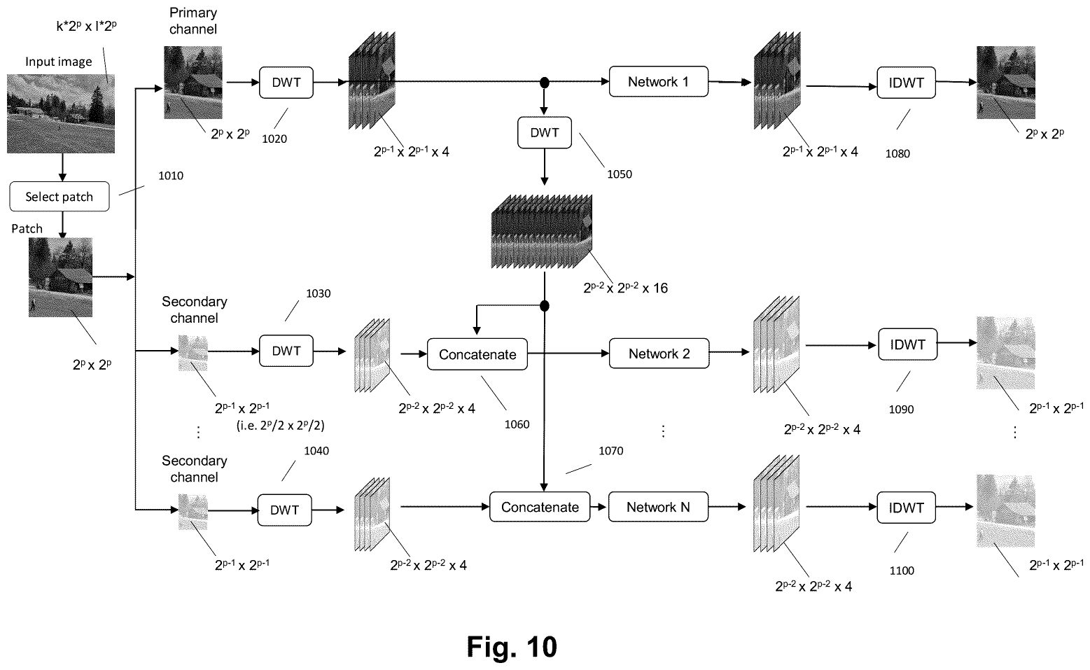

As already mentioned channels of different sizes corresponding to different channel resolutions can also be handled. FIG. 10 shows an embodiment wherein the size of the primary channel is four times the sizes of each of the secondary channels. An image with a size of k·2^{p}×1·2^{p} with integers k, 1 and p is split into k×1 square patches each having the size 2^{p}×2^{p}. If the image cannot be split into k×1 square patches, it is padded before splitting. A patch of size 2^{p}×2^{p} is selected 1010 for processing and split into (distorted) channels, for example, color channels as RGB or YUV (luminance and chroma) channels. One of the channels is selected or pre-determined as a primary channel. The other channels are secondary channels that are processed based on information related to the primary channel. The primary channel has the size 2^{p}×2^{p} and each of the secondary channels has the size 2^{p-1}×2^{p-1}. For example, the processed path of the image has the YUV 420 format.

All channels are processed 1020, 1030, 1040 with a two-dimensional DWT. Any kind of wavelet considered appropriate might be used for the DWT. For example, the Haar wavelet or a Daubechies wavelet may be considered as a suitable choice. Application of a DWT to the pixel values of the pixels of the primary channel 1020 results in a DWT transformed primary channel with the size 2^{p-1}×2^{p-1}×4 with the third dimension given by the spatial low-frequency sub-band LL and the spatial high-frequency sub-bands HL, LH and HH. Correspondingly, application of DWTs to the pixel values of the pixels of the secondary channels 1030, 1040 results in DWT transformed secondary channels with the sizes 2^{p-2}×2^{p-2}×4. The DWT transformed primary channel with the size 2^{p-1}×2^{p-1}×4 is processed by Network 1 that is designed to have input and output of the same sizes. The output of Network 1 with the size 2^{p-1}×2^{p-1}×4 is subject to inverse DWT 1080 to obtain the modified/enhanced primary channel with the size of 2^{p-1}×2^{p-1}.

In order to use the DWT transformed primary channel as auxiliary information for the processing of the (DWT transformed) secondary channels the first two dimension have to be the same. Therefore, the DWT transformed primary channel with size 2^{p-1}×2^{p-1}×4 is subject to a further (cascaded) DWT 1050 to obtain a, auxiliary DWT transformed primary channel with size 2^{p-2}×2^{p-2}×16. The thus resulting three-dimensional array is concatenated 1060, 1070 with the arrays of the DWT transformed secondary channels and the thus resulting concatenated arrays are fed into networks Network 2 to network N, respectively. The networks Network 2 to network N are designed to have inputs larger in the third dimension and outputs having sizes in the third dimension of exactly 4 (due to the DWT/inverse DWT) and the outputs of the networks Network 2 to network N are subject to respective inversed DWTS 1090 and 1100 to obtain modified/enhanced secondary channels with sizes 2^{p-2}×2^{p-2}. An enhanced (substantially undistorted) patch with size 2^{p}×2^{p} based on a combination of the modified/enhanced primary and secondary channels. A next patch may be selected and processed as described above. All processed patches can be assembled to build the reconstructed image, and any padding (if needed) is removed.

The configuration illustrated in FIG. 10 provides the same advantages as the configuration described with reference to FIG. 9. Whereas in the embodiments described with reference to FIGS. 9 and 10 a DWT is employed, alternatively, any other spatial frequency transform considered suitable may be employed. Particularly, transforms may be selected that do not result in down sampling by a factor of 2 in the height and width dimensions of the image region.

The neural networks employed in the embodiments described with reference to FIGS. 9 and 10 may be convolutional neural networks. It is, furthermore, noted that the embodiments described with reference to FIGS. 9 and 10 may be modified in order to be configured to carry out the pixel shift and pixel un-shift operations described above before the DWT and after the inverse DWT (or any other spatial frequency transform used), respectively.

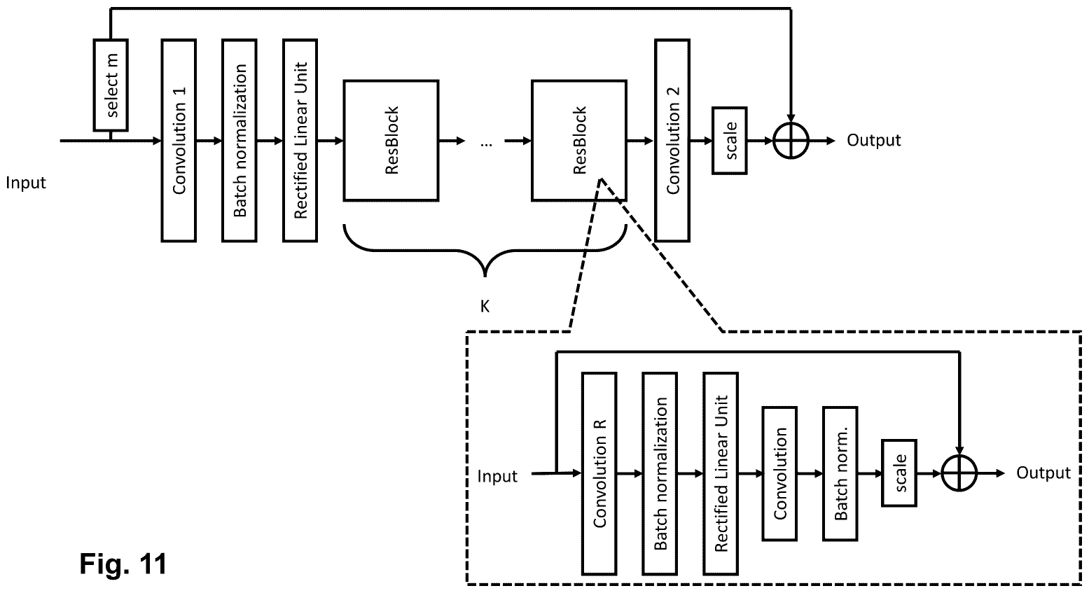

FIG. 11 illustrates a particular example of a convolutional neural network that might be employed in the embodiments described with reference to FIGS. 9 and 10. Besides the number of input tensor layers the topology of all of the networks illustrated in FIGS. 9 and 10 may be the same or similar to each other.

For processing of the DWT transformed primary channel, the number of input tensor layers is 4. For processing the DWT transformed secondary channels, the inputs of the involved neural networks are larger to accommodate both the DWT transformed secondary channel itself and the DWT transformed primary channel concatenated in the third dimension. Additionally, each of the two concatenated channels might have its third dimension larger than 4, if one of the channels (for example, the primary channel) was larger and a cascaded DWT was used to equalize the first two dimensions. For example, if one channel was 2ⁿ times larger than the other, the number of the input tensor layers for the secondary channel is 4·(2ⁿ+1). In the case of processing YUV 420 content, the size of the primary channel is 4 times the size of the secondary one (2 times in each direction), N=2 and the input tensor layers are 20. The number of the output tensor layers is 4 (as required by the IDWT block which follows), and it is controlled by the size of the output convolution block (“Convolution 2” in FIG. 11). When the number of input and output tensor layers differs from each other, the “select m” block shown in FIG. 11 extracts only the first m tensor layers from the p (>m) input tensor layers (thus omitting the information which originates from the auxiliary input) and sends them to the summation block at the output.

A number of cascaded Residual blocks (ResBlocks) is arranged between the input and the output convolution blocks Convolution 1 and Convolution 2 and can be configured for residual learning during a training phase as well as neural network inference. According to one embodiment, 8 ResBlocks with 48 features each are employed but other combinations are possible. Rectified Linear Unit (ReLU) layers are used form implementing activation functions, for example. Batch normalization layers and scaling layers well known in the context of CNNs may be employed in order facilitate the training process. According to some embodiments, such scaling layer may apply a linear transformation to the preceding layer, e.g. by multiplying each element of the preceding layer by a scaling coefficient. This may be achieved by a single scaling coefficient or by a layer with multiple identical weights. According to some embodiments, scaling might be selectively applied to some elements of the preceding layer, e.g. using a scaling layer were only selected elements have weights to achieve the desired scaling value.

According to some embodiments, such scaling layer may be represented by one or more scaling values used as multipliers of preceding block elements. Different arrangements of the scaling layer in the convolutional neural network layer configurations are intended. According to one configuration, the scaling layer could be arranged subsequent to output convolution block (“Convolution 2” in FIG. 11) as shown in FIG. 11 above. According to another configuration, the scaling layer could also be arranged before the output of each ResBlock, as shown in FIG. 11 below. The scaling layer may be adapted to control the ratio of processed to unprocessed input to be summed before output. According to some embodiments, the one or more scaling values of the scaling layer may have default values obtained during the training process. According to some embodiments, the encoder might also use a different values for a given image, image component or image region. In such case, the different values may be provided by signaling one or more scale values from the encoder to the decoder. In some embodiments, a configuration where a single scaling element is used for all elements in the preceding layer may be preferable. In these embodiments, signaling a single scale value per ResBlock allows for large flexibility in controlling the output of the neural network.

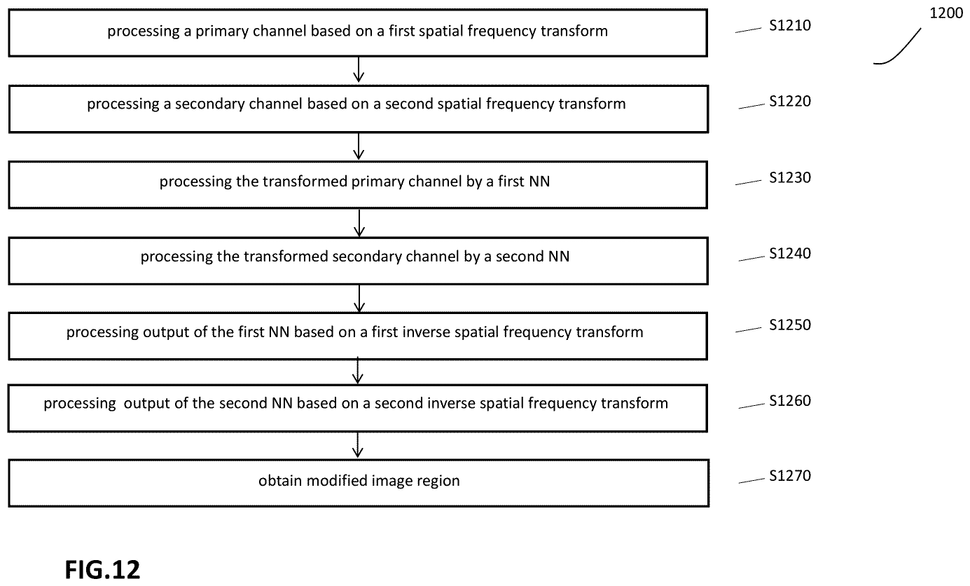

In particular, it is provided a method of modifying an image region represented by two or more image channels as it is illustrated in FIG. 12. The term “modifying” here refers to any modification such as image filtering or image enhancement, or the like. In principle, the image can be a patch of a predetermined size corresponding to a part of an image or a part of a plurality of images, or it can be an image or a plurality of images. The two or more channels may be color channels or other channels such as depth channels or multi-spectral image channels or any other feature channels. One of the channels is a primary channel and another one of the channels is a secondary channel. More than one secondary channel may be present. The method may comprise selecting one of the two or more image channels as a primary channel and another at least one of the two or more image channels as a secondary channel. It is noted that the primary channel can (according to some embodiments) also be considered as a leading channel. The secondary channel can (according to some embodiments) also be considered as a responding/reacting channel. For example, two or more secondary channels can be selected.

The method 1200 of modifying an image region represented by two or more image channels illustrated in FIG. 12 comprises the step of processing S1210 a primary channel of the two or more image channels based on a first spatial frequency transform to obtain a transformed primary channel. Similarly, a secondary channel of the two or more image channels different from the primary channel is processed S1220 based on a second spatial frequency transform to obtain a transformed secondary channel. It goes without saying that the more than one secondary channel can be processed by more than one second spatial frequency transform (and more than one second neural network, see below). The first and second spatial frequency transforms may be selected from a group consisting of a wavelet transform (DWT or stationary wavelet transform), a Discrete Fourier Transform, a Fast Fourier Transform and energy compacting transforms comprising a Discrete Cosine Transform. According to an example, first and second spatial frequency transforms may be the same kind of spatial transform of the group.

Further, the method 1200 comprises processing S1230 the transformed primary channel by means of a first neural network to obtain a modified transformed primary channel and processing S1240 the transformed secondary channel based on the transformed primary channel (used as auxiliary information) by means of a second neural network to obtain a modified transformed secondary channel. The first and second neural networks may be different from each other. If the primary channel and the secondary channel have different sizes (according to different resolutions of the image region in the different channels), a cascaded spatial frequency transform may be employed for the larger one of the channels to adjust the height and width dimensions of the transformed channels to each other (see description with reference to FIG. 10 above).

The output of the first neural network, i.e., the modified transformed primary channel, is processed S1250 based on a first inverse spatial frequency transform (corresponding to the first spatial frequency transform) to obtain a modified primary channel. Similarly, the modified transformed secondary channel is processed S1260 based on a second inverse spatial frequency transform to obtain a modified secondary channel. Subsequently, a modified image region can be obtained S1270 based on the modified primary channel and the modified secondary channel. The procedure can be repeated for another selected image region. After all image regions of an image to be processed are processed by the method 1200 illustrated in FIG. 12, a modified version of the entire image can be obtained.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

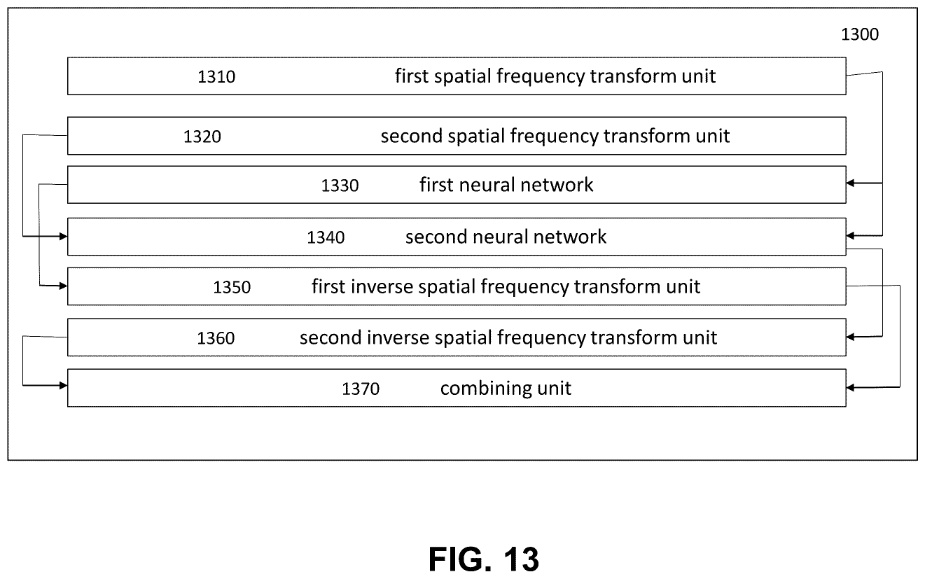

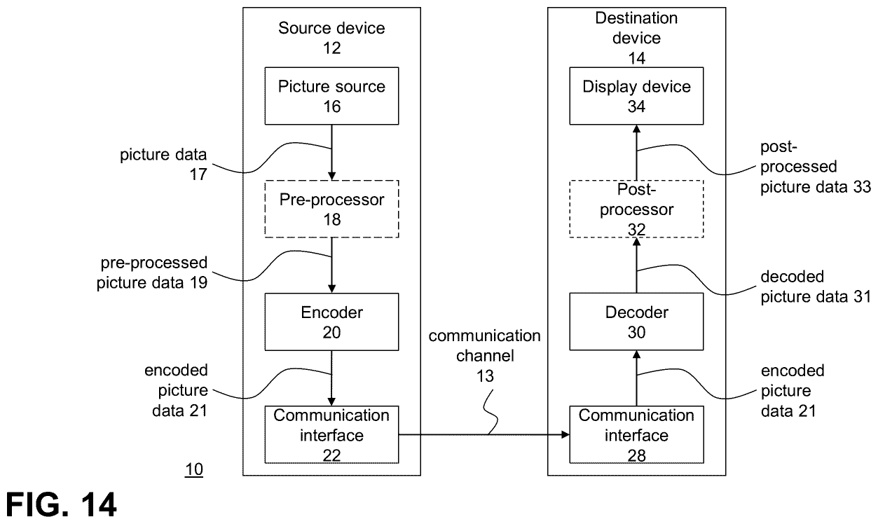

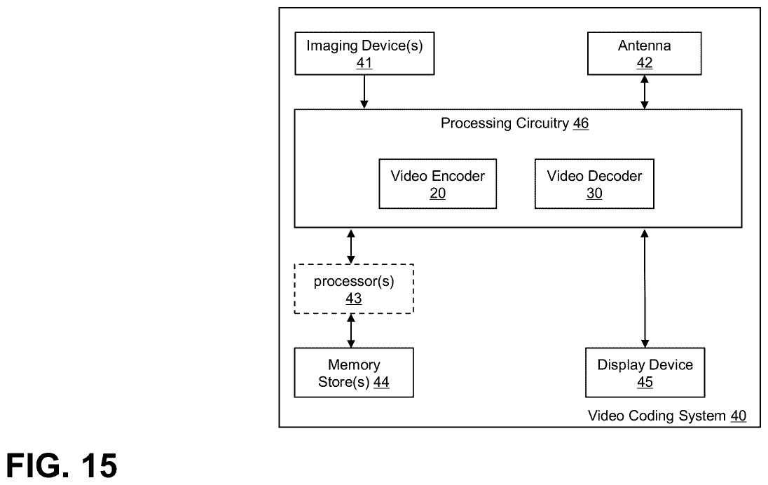

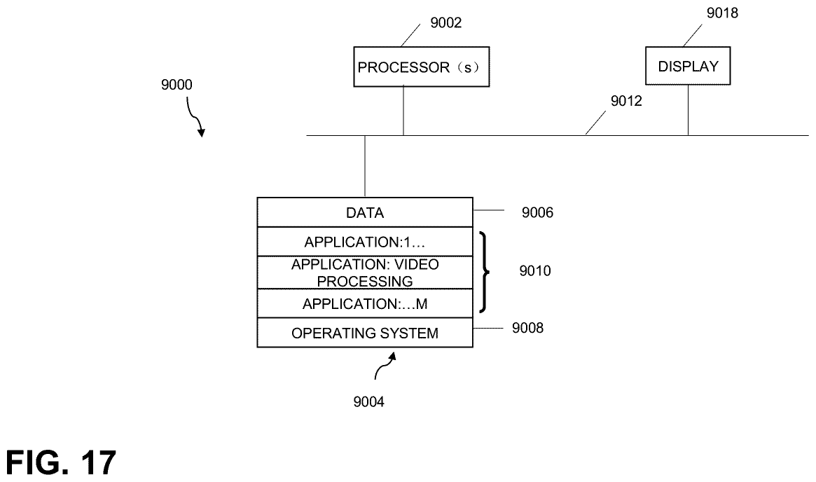

The method 1200 illustrated in FIG. 12 can be implemented in an apparatus 1300 configured for modifying an image region illustrated in FIG. 13 and this apparatus 1300 can be configured to carry out the steps of the method 1200 illustrated in FIG. 12. The apparatus 1300 can be comprised by an encoder (for example, encoder 20 shown in FIGS. 14 and 15) or decoder (for example, decoder 20 shown in FIGS. 14 and 15) or it can be comprised by the video coding device 8000 shown in FIG. 17 or the apparatus 9000 shown in FIG. 18.

The apparatus 1300 for modifying an image region represented by two or more image channels illustrated in FIG. 13 comprises a first spatial frequency transform unit 1310 configured for processing a primary channel of the two or more image channels to obtain a transformed primary channel and a second spatial frequency transform unit 1320 configured for processing a secondary channel of the two or more image channels different from the primary channel to obtain a transformed secondary channel.

Furthermore, the apparatus 1300 comprises a first neural network (NN) 1330 configured for processing the transformed primary channel to obtain a modified transformed primary channel and a second neural network (NN) 1340 configured for processing the transformed secondary channel based on the transformed primary channel to obtain a modified transformed secondary channel. A first inverse spatial frequency transform unit 1350 configured for processing the modified transformed primary channel to obtain a modified primary channel is also comprised by the apparatus 1300. Similarly, a second inverse spatial frequency transform unit 1360 configured for processing the modified transformed secondary channel to obtain a modified secondary channel is comprised by the apparatus 1300.

Further, the apparatus 1300 comprises a combining unit 1370 configured for obtaining a modified image region based on the modified primary channel and the modified secondary channel.

### Some Exemplary Implementations in Hardware and Software

The corresponding system which may deploy the above-mentioned processing, in particular, by an encoder-decoder processing chain is illustrated in FIG. 14. FIG. 14 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 14, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 14 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 14 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 14 may vary depending on the actual device and application.

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 15.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 14 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

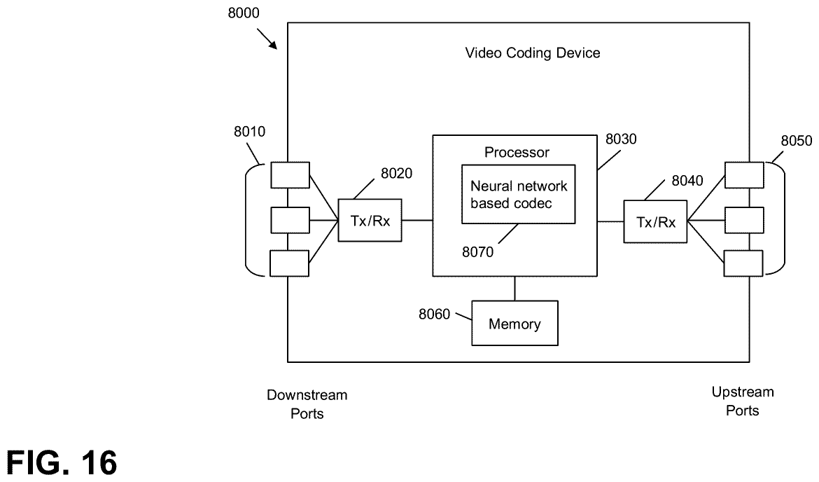

FIG. 16 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 14 or an encoder such as video encoder 20 of FIG. 14.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

FIG. 17 is a simplified block diagram of an apparatus that may be used as either or both of the source device 12 and the destination device 14 from FIG. 14 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

What is claimed is:

1. A method of modifying an image region represented by two or more image channels, the method comprising:
processing a primary channel of the two or more image channels based on a first spatial frequency transform to obtain a transformed primary channel;
processing a secondary channel of the two or more image channels different from the primary channel based on a second spatial frequency transform to obtain a transformed secondary channel;
processing the transformed primary channel via a first neural network to obtain a modified transformed primary channel;
processing the transformed secondary channel based on the transformed primary channel via a second neural network to obtain a modified transformed secondary channel;
processing the modified transformed primary channel based on a first inverse spatial frequency transform to obtain a modified primary channel;
processing the modified transformed secondary channel based on a second inverse spatial frequency transform to obtain a modified secondary channel; and
obtaining a modified image region based on the modified primary channel and the modified secondary channel.

2. The method according to claim 1, wherein one or both of the first spatial frequency transform and the second spatial frequency transform are selected from the group consisting of: a wavelet transform, a Discrete Fourier Transform, a Fast Fourier Transform, and an energy compacting transform comprising a Discrete Cosine Transform.

3. The method according to claim 2, wherein both the first spatial frequency transform and the second spatial frequency transform are one of: a wavelet transform, a Discrete Fourier Transform, a Fast Fourier Transform, an energy compacting transform, and a Discrete Cosine Transform.

4. The method according to claim 2, wherein one or both of the first spatial frequency transform and the second spatial frequency transform are a wavelet transform selected from the group consisting of: a discrete wavelet transform and a stationary wavelet transform.

5. The method according to claim 1, further comprising selecting the primary channel from the two or more image channels.

6. The method according to claim 5, further comprising selecting the secondary channel from the two or more image channels.

7. The method according to claim 6, wherein the primary channel and the secondary channel are selected from the two or more image channels based on an output of a classifier operating based on another neural network.

8. The method according to claim 1, wherein the processing of the transformed secondary channel based on the transformed primary channel comprises concatenating a second three-dimensional tensor representing the transformed secondary channel with a first three-dimensional tensor representing the transformed primary channel.

9. The method according to claim 1, wherein a size of the primary channel is different from a size of the secondary channel.

10. The method according to claim 9, wherein when the size of the primary channel is larger than the size of the secondary channel:
the processing the transformed primary channel via the first neural network is performed based on at least one additional first spatial frequency transform to obtain an auxiliary transformed primary channel of the same size as the transformed secondary channel in a height and in a width direction of the image region; and
the processing the transformed secondary channel based on the transformed primary channel via the second neural network is based on the auxiliary transformed primary channel, and
wherein when the size of the secondary channel is larger than the size of the primary channel:
the processing the transformed secondary channel based on the transformed primary channel via the second neural network is based on at least one additional second spatial frequency transform to obtain an auxiliary transformed secondary channel of the same size as the transformed primary channel in a height and in a width direction of the image region, and
the processing of the transformed secondary channel based on the transformed primary channel via the second neural network comprises processing of the auxiliary transformed secondary channel based on the transformed primary channel.

11. The method according to claim 10, wherein the processing of the transformed secondary channel based on the transformed primary channel via the second neural network comprises:
when the size of the primary channel is larger than the size of the secondary channel, concatenating a second three-dimensional tensor representing the transformed secondary channel with a first three-dimensional tensor representing the auxiliary transformed primary channel; and
when the size of the secondary channel is larger than the size of the primary channel, concatenating a second three-dimensional tensor representing the auxiliary transformed secondary channel with a first three-dimensional tensor representing the transformed primary channel.

12. The method according to claim 1, further comprising splitting an image into a plurality of image regions that comprise the image region and padding image regions resulting from the splitting that are not square in height and width dimensions of the image regions such that they are square in the height and width dimensions of the image region.

13. The method according to claim 1, further comprising:
splitting an image into image regions comprising the image region; and
wherein when the image cannot be split only into image regions that are square in height and width dimensions of the image regions, padding the image such that the image is split into image regions only that are all square in the height and width dimensions of the image regions comprising the image region.

14. The method according to claim 1, wherein the first neural network and the second neural network are operated independently from each other, and
wherein weights of one of the first neural network and the second neural network are determined and used independently from weights of the other one of the first neural network and the second neural network.

15. The method according to claim 1, wherein each of the first neural network and the second neural network is or comprises a convolutional neural network,
wherein the convolutional neural network comprises at least one residual network component, and
wherein the convolutional neural network uses a scaling layer represented by one or more scaling values.

16. A method for encoding an image or a video sequence of images, the method comprising:
obtaining an original image region,
encoding the obtained original image region into a bitstream, and
applying the method according to claim 1 for modifying an image region obtained by reconstructing the encoded original image region.

17. A method for decoding an image or a video sequence of images from a bitstream, the method comprising:
reconstructing an image region from the bitstream; and
applying the method according to claim 1 for modifying the reconstructed image region.

18. A method for decoding an image or a video sequence of images from a bitstream, the method comprising:
parsing the bitstream to obtain at least one of:
an indication that the method according to claim 1 for modifying an obtained image region is not to be applied for the image region,
an indication of the primary channel for the region,
an adaption of one or more weights of at least one of the first neural network and the second neural network; and
reconstructing an image region from the bitstream, and
modifying, when the indication of the primary channel for the region indicates a selected primary channel, the reconstructed image region according to the method according to claim 1 with the indicated primary channel as the selected primary channel.

19. A non-transitory computer readable medium having stored thereon processor executable instructions that, when executed by one or more processors, cause the one or more processors to perform the method according to claim 1.

20. An apparatus for modifying an image region represented by two or more image channels, the apparatus comprising:
processing circuitry comprising:
a first spatial frequency transform unit configured to process a primary channel of the two or more image channels to obtain a transformed primary channel;
a second spatial frequency transform unit configured to process a secondary channel of the two or more image channels different from the primary channel to obtain a transformed secondary channel;
a first neural network configured to process the transformed primary channel to obtain a modified transformed primary channel;
a second neural network configured to process the transformed secondary channel based on the transformed primary channel to obtain a modified transformed secondary channel;
a first inverse spatial frequency transform unit configured to process the modified transformed primary channel to obtain a modified primary channel;
a second inverse spatial frequency transform unit configured to process the modified transformed secondary channel to obtain a modified secondary channel; and
a combining unit configured to obtain a modified image region based on the modified primary channel and the modified secondary channel.
